(19) United States
(12) Patent Application Publication
(10) Pub. No.: US 2009/0222858 A1
(43) Pub. Date: Sep. 3, 2009

(54) System and Method for Creating Electronic Guides Based on Presence and Group Membership

(75) Inventors: Johan Hjelm, Tokyo (JP); Ayodele Damola, Kista (SE); Hajime Kasahara, Yokohama (JP); Shingo Murakami, Kanagawa (JP); Toshikane Oda, Tokyo (JP)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/039,772

(22) Filed: Feb. 29, 2008

(51) Int. Cl. G06F 3/00

(52) U.S. Cl. 725/47

(57) ABSTRACT

A network server comprises a controller that creates and distributes an electronic guide to the members of an affinity group based on the presence statuses of one or more of the group members. The electronic guide identifies the title and location of one or more media files stored in a home system of the group members. The group members may view the electronic guide, and select a media file to render on their own home system.

### TECHNICAL FIELD

The present invention relates generally to communication networks, and particularly to communication networks configured to allow members of a group to access and share media files associated with the group members.

### BACKGROUND

Internet Protocol Television (IPTV) is a system that provides digital television service to subscribers. Generally, a subscriber has a device which receives the television signal, and which facilitates user requests to access and receive television content from a variety of different sources. Such a device may comprise, for example, a set-top box (STB) or a television set (TV) configured with the appropriate software. However, rather than delivering the content via traditional broadcast or cable formats, service providers deliver the television content over Internet Protocol (IP) based computer networks.

Currently, subscribers to both cable and broadcast television services, as well as those subscribing to similar services delivered over IP networks, can invoke an on-screen menu called an Electronic Program Guide (EPG) to view information about the available IPTV content. Generally, EPGs employ an interactive graphical user interface (GUI) to permit users to view information about current and future programs, navigate to different channels or programs, and select a particular program, for viewing. In suitably equipped systems, such as STBs with the appropriate software and hardware, users may also record selected programs onto a hard disk for later viewing. These types of services may also be available to a user over the network.

Conventional IPTV systems provide a generic EPG to identify the television programs that all users have access to. Some, however, also allow individual subscribers to personalize their EPGs according to their preferences. Additionally, other IPTV systems allow groups of people, such as the members of a family, to personalize an EPG according to the common likes and dislikes of all family members.

Typically, such family-based EPGs show programs prioritized based on popularity. However, what is popular to one family member is usually not popular with another. Some systems consider individual family member profiles when creating the family EPG, but only to create prioritized lists of programs that the family members have already seen. These systems do not generate prioritized lists of content that individual family members can potentially view. Additionally, conventional systems do not generate EPGs to include the titles of media files from the personal collections of other users. Nor do they consider the viewing preferences of other users, which could affect what a given user might find popular.

### SUMMARY

The present invention provides a method of creating and distributing an electronic guide to users, such as an electronic program guide (EPG) or an electronic service guide (ESG), based on membership in a group and presence information. The electronic guide comprises information that includes, but is not limited to, the titles of media files stored on the users' respective home systems and the locations of those media files. A server generates the electronic guide and, once generated, distributes the electronic guide to the members of the group. As changes occur, the server dynamically generates and distributes an updated electronic guide to the group members. In a preferred embodiment, the server comprises a network server residing in a network, and has a client-server relationship with a variety of different client devices displaying the electronic guide. In another embodiment, however, the server comprises a peer node in a peer-to-peer relationship with other peer nodes displaying the electronic guide.

In one embodiment, the users are registered members of an affinity group that inform one another of their presence status using a presence service. Each group member has a media system that is capable of storing and rendering media files, such as audio and video files. The media files may be stored, for example, on a home server in the group members' home systems. The media files may also be stored remotely on a server in a network, and retrieved for rendering on a user's home system or other rendering device. The network server uses the presence service to subscribe to and receive presence updates from each group member.

According to the present invention, the presence updates include information about the shared media files of each of the group members. The information may comprise, for example, the titles of one or more media files stored on a given group member's home media system that is being shared with the group. The network server generates the electronic guide that includes the information about the shared media files and distributes the electronic guide to the group members.

Upon receipt, the group members can display the electronic guide on their home systems to view the media files, and select an available media file from the electronic guide. The selected media file is then delivered from its storage location on the home server or networked storage location of one group member to a rendering device, such as a digital television display, of another group member. This allows group members to share media files and other media assets across a communication network, even though those assets are located in the home system of another group member. Membership in the group serves to authenticate a group member to allow them to access the media files of the other group members.

### BRIEF DESCRIPTION OF THE DRAWINGS

FIG. 1 illustrates a system suitable for generating Electronic Guides according to one embodiment of the present invention.

FIG. 2 illustrates exemplary signaling and data communication paths between some of the entities of FIG. 1 according to an alternate embodiment of the present invention.

FIG. 3 is a flow chart illustrating one embodiment of the present invention.

FIG. 4 is a call flow diagram illustrating how a network server creates and disseminates electronic guides to group members based on their group membership and presence according to one embodiment of the present invention.

FIG. 5 is a flow chart that illustrates how a group member's home system uses presence updates to indicate shared media content to a network server.

FIG. 6 illustrates exemplary signaling and data communication paths between some of the entities of FIG. 1 according to an alternate embodiment of the present invention.

FIG. 7 is a block diagram illustrating some of the component parts of a network server configured to create and disseminate electronic guides to the members of a group according to one embodiment of the present invention.

### DETAILED DESCRIPTION

The present invention is a system and method for creating and distributing an interactive on-screen menu for a group of users based on the presence of the group members. In one embodiment, the menu is an Electronic Program Guide (EPG) that lists a variety of personal media assets associated with each of the group members, such as audio and video files that are stored on the respective home servers of the group members. In another embodiment, the menu comprises an Electronic Service Guide (ESG) that identifies a variety of services available from each of the group members. With the present invention, the group members can publish their respective media assets and/or services to the group to share them with the other group members. Additionally, membership in the group may be used to authorize a user's access to the electronic guide, as well as the media assets and/or services of another group member.

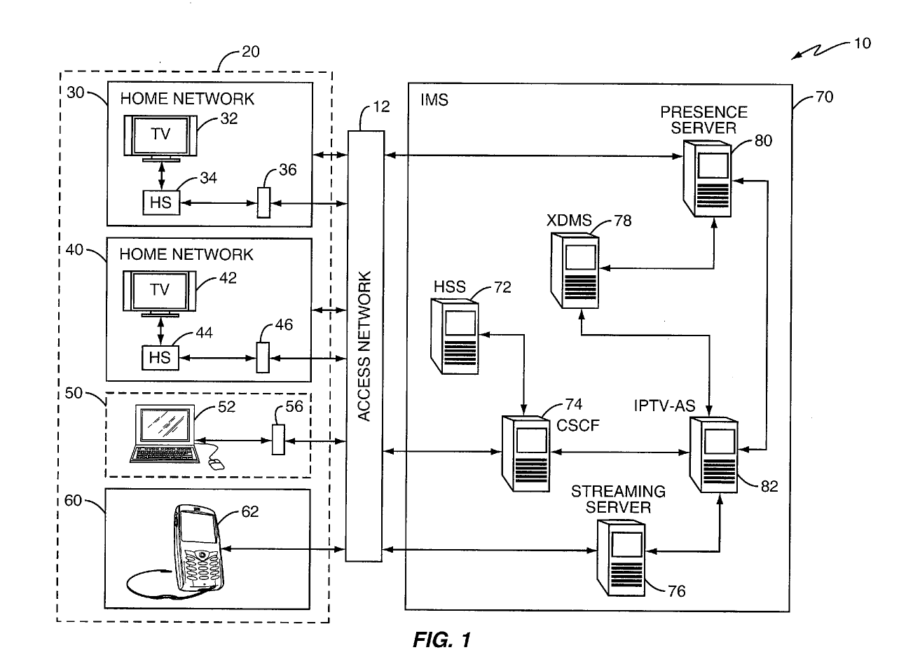

FIG. 1 is a block diagram illustrating the architecture of a system suitable for sharing media assets and/or services between the members of a group based on the presence of the group members. System 10 comprises an access network (AN) 12 that communicatively interconnects an end-user media system 20 of one or more group members to a network under the control of the Internet Protocol Multimedia Subsystem (IMS) 70. In this embodiment, the end-user media system 20 refers collectively to a plurality of individual end-user systems 30, 40, 50, and 60, each of which is associated with a different member of the group. However, two or more of the individual systems 30, 40, 50, and 60 may be associated with a single group member.

As described below in more detail, a network server in the IMS 70 receives presence updates for the group members. The presence updates include information about each group member's media assets, such as the titles of the media files stored on each of the end-user systems 20. Based on this information, the network server generates and publishes an EPG to the group members. The EPG includes a listing of the available media files of each group member. Each group member can view the EPG, and select one or more media files stored on the other systems 30, 40, 50, 60 for rendering on their own system.

Access network (AN) 12 provides access to the network controlled by the IMS 70, and is capable of communicating video and audio data between the subscriber equipment and the network controlled by the IMS 70 using well-known interfaces and signaling protocols. The IMS 70 is not dependent on the technology specific to the AN 12. Therefore, AN 12 may be any packet-switched network known in the art. Suitable networks may be any fixed or mobile network including, but not limited to, Universal Mobile Telecommunications System (UMTS), cdma2000, General Packet Radio Service (GPRS), Enhanced GPRS (EGPRS) networks, and Asymmetric Digital Subscriber Line (ADSL) networks.

Each group member is a member of a group registered with the IMS 70. In FIG. 1, there are four group members—each having their own system 30, 40, 50, 60, and a variety of equipment to render media files such as audio and/or video files. For example, systems 30 and 40 comprise home theater systems. Each home theater system respectively includes a Digital Media Rendering Device (DMR) such as TV 32, 42, a Home Server (HS) 34, 44, and a Home IMS Gateway (HIGA) 36, 46. While not required for the present invention, the home theater systems 30, 40 have similar components and functionality. Therefore, the following description applies to both systems 30, 40, even though only system 30 is specifically mentioned.

The DMR may be any device capable of rendering digital video and audio to a user. In one preferred embodiment, the DMR comprises a digital TV 32 that is part of a Digital Living Network Alliance (DLNA) network. A DLNA network allows different electronic devices, such as TV 32, to interoperate with other electronic devices, such as any computing and mobile communication devices associated with the group member.

Generally, the DMR is equipped with software that makes it DLNA compliant. Thus, many different types of devices can be DMRs in the present invention. Suitable examples of suitable DMRs include, but are not limited to, Liquid Crystal Displays (LCDs), Plasma televisions, Personal Computers (PCs), or any other device capable of rendering a television signal. In some embodiments, a set-top box is associated with the TV 32. The set-top box, which is described in more detail later, could include the software that makes it DLNA compliant.

As is known in the art, the group member can store media files locally on the HS 34. Using the EPG, the group member can select a video, for example, and view the selected video on TV 32. The group member can also selectively control the video playback using a remote control unit (not shown) as is known in the art. Additionally, audio and/or video files may be delivered to system 30 from a streaming media server, such as an IPTV server, which is associated with the IMS system 70. In these cases, the media files may be delivered to HS 34 for storage, or to the TV 32 for playback.

The HIGA 36 includes a wide array of functionality that bridges the gap between IMS services such as IPTV, and non-IMS enabled devices, such as HS 34, TV 32, a home stereo, a personal computer, a media player, and the like. The HIGA 36 may be implemented in a physical box that is separate from the HS 34 and/or TV 32, or integrated with these devices. In this embodiment, the HIGA 36 comprises a separate device that is configured to interconnect the HS 34 and TV 32 to the IMS 70 via the AN 12. To facilitate communication, the HIGA 36 includes a device database, containing device addresses and descriptions (as standardized by UPnP) which identifies the addresses of the local home-based non-IMS devices and the network devices that offer the IMS services. The HIGA 36 generates this database as a result of the discovery mechanism which is part of the home networking protocol (UPnP). This is done automatically when a device is connected to the home network. Alternatively if the device is a SIP or IMS device it would perform an explicit register to the HiGA and will thereby be also added to the device DB. The user can then optionally add preferences associated to devices in device DB (e.g. on which one of two discovered TVs to display personalized EGP)

As described in more detail later, the HIGA 36 can send presence updates to PS 80 in IMS 70. These updates can include a list of media files stored on HS 34, and various interfaces that allow the HIGA 36 to communicate with remote entities using the appropriate protocols. In the present invention, the HIGA 36 periodically receives and stores an EPG generated for the group members from IMS 70. The EPG includes a listing of the media files stored at each system 30, 40, 50, 60 as well as the addresses of each media file. Using a remote control unit or similar device, the group member can display the group EPG on TV 32 and select a desired media file. The HIGA 36 can then retrieve the selected file from the associated address or location, even if the asset is stored on one of the systems 40, 50, 60 of another group member, and deliver it to TV 32 for rendering.

In addition to home theater systems 30, 40, the present invention may also be used with a personal computing device (PC) 52 associated with another system 50. PC 52 may comprise a variety of audio and/or video files stored on its hard drive or other associated memory. The group member associated with system 50 may select a media file to render on PC 52, and share these media files with the other group members for rendering on their respective systems 30, 40, 60. The group member may also receive the group EPG detailing the media files and services of the other systems 30, 40, 60, and select media files from the EPG for rendering as previously described.

As seen in FIG. 1, systems 30, 40, and 50 each have an HIGA to facilitate communications with the IMS 70 as previously described. However, those skilled in the art will appreciate that the present invention neither needs nor requires an independent HIGA component. Some or all of these systems 30, 40, 50 may integrate the HIGA functionality with another component, such as the HS, the set-top box, the TV or the PC.

One such system, home system 60, illustrates this integrated functionality. System 60 includes a wireless communication device 62 capable of communicating voice and/or data with one or more remote parties via AN 12, and rendering audio and video to its user. Generally, audio and video files are stored in a memory within device 62 and are shared with the other group members as previously described. In this embodiment, device 62 is an IMS client device. Therefore, the functionality provided by the HIGAs of the other systems is included with the device 62 and a separate HIGA is not needed.

The IMS 70 provides access independent, IP-based multi-media services to the group members and supports a variety of IP services including voice over IP (VoIP), IPTV, email, web browsing, videoconferencing, instant messaging, presence and other services. Generally, the IMS 70 uses open interfaces and an access independent session control protocol (SCP), such as the Session Initiation Protocol (SIP), to support multi-media applications. Session description protocol (SDP) is used for media negotiation and is described in IETF RFCs 2327 and 3264, both of which are expressly incorporated herein by reference.

The IMS 70 includes a variety of servers and databases, some of which are illustrated in FIG. 1. As seen in FIG. 1, the IMS 70 components comprise a Home Subscriber Server (HSS) 72, a Call/Session Control Function Server (CSCF) 74, a Streaming Server (SS) 76, an XML Document Management Server (XDMS) 78, a Presence Server (PS) 80, and an IPTV Acquisition Server (IPTV-AS) 82.

The HSS 72 functions as a central repository for user-related subscription data required to handle multimedia transactions. Such data includes, but is not limited to, location information, security information for both authentication and authorization of group members, user profiles that identify, inter alia, which IMS services a group member subscribes to, and which CSCF 74 serves which group member. IMS 70 may contain multiple HSSs 72; however, in such cases, additional components or databases may be used to map group member addresses to their associated HSS 72.

Those skilled in the art will appreciate that the HSS 72 is not the only entity that can store and maintain the user profile information according to the present invention. Rather, any system capable of storing and maintaining user profile information, and which is associated with the user via mediation with the HSS 72, is suitable for use with the present invention. The XDMS 78, which is defined by the applicable Open Mobile Alliance (OMA) standards, is one example of an entity suitable for storing and managing the user profile information according to the present invention.

The CSCF 74 is a SIP server that communicates with the HSS 72, the AN 12, and the IPTV-AS 82. Generally, the CSCF 74 is configured to process SIP signaling messages in IMS 70 and perform session control functions for the group members. The CSCF 74 comprises software and hardware modules that provide SIP routing services, translation services, and enforce network policies. For example, the CSCF 74 may be configured to allow only authorized group members to perform certain media-related functions, such as establish a media session with IMS 70.

The SS 76 comprises a server that provides synchronous and asynchronous delivery of an audio and/or video stream from IMS 70 to the one or more of the end-user systems 20. In FIG. 1, the SS 76 facilitates “Real-Time” or “On-Demand” type services provided by the IMS 70, and routes data to the end-user systems 20 that requested the content. However, in some cases, SS 76 may also provide presence status updates to PS 80, either individually or through the mediation of the IPTV AS 82. These updates may include information detailing the available media files on the group member's system. As described in more detail below, this allows the members of a group to share applications and/or media files across the network, as well as receive interactive audio and video streams such as video conferencing.

The PS 80 provides presence services to the group members. As is known in the art, a presence service provides information about a group member's status and location to the other group members. For example, a group member may be available or unavailable to communicate data with another group member. Further, when available, a given group member with a device of limited capabilities may only be able to provide or receive limited types of data. Therefore, the PS 80 may store information defining a given devices' current operational capabilities.

The IPTV-AS 82 comprises a control function that generally controls the SS 76 to acquire video and audio content from a variety of sources such as television broadcasting stations and databases of stored audio/video. In the present invention, however, the IPTV-AS 82 also controls the SS 76 to receive audio/video content from a home server 34, 44, PC 52, or wireless communication device 62 for routing to one or more of the other group members. Typically, the video and audio content arrives at the SS 76 encoded according to any of a variety of known encoding standards. Such standards include, but are not limited to, MPEG-2, and H.264 or VC-1, which are two high-definition video standards designed for television screens. Upon receipt, the IPTV-AS 82 may control the SS 76 to route the content to the CSCF 74 for delivery to the systems 30, 40, 50, or to deliver the content to the mobile-based system 60. In addition, IPTV-AS 82 may include, or interoperate with, one or more functions or systems designed to facilitate or control billing, authentication, and authorization of group members.

According to the present invention, the IPTV-AS 82 includes software and hardware configured to request/receive information relating to the media files stored at one or more of the systems 30, 40, 50, 60. The IPTV-AS 82 receives this information responsive to changes or updates in the presence status of the group members. For example, the IPTV-AS 82 may SUBSCRIBE to receive updated presence information from systems 30, 40, 50, 60, whenever the presences status of the associated group member changes. The presence information may include, for example, the group member's presence status. Additionally, however, the presence information may also include attributes or other data that identify the title of a video or audio file, the current location (e.g., a Uniform Resource Identifier (URI) or other identifier) of the audio/video file at the group member's system, or the audio/video file itself. The IPTV-AS 82 receives this information from the group members, and compiles it to generate a group EPG. The IPTV-AS 82 then outputs at least a part of the group EPG to each group member. Any group member can then view the group EPG and select a video or audio file from this list for rendering, even if the selected file is resident on another group member's home system 10.

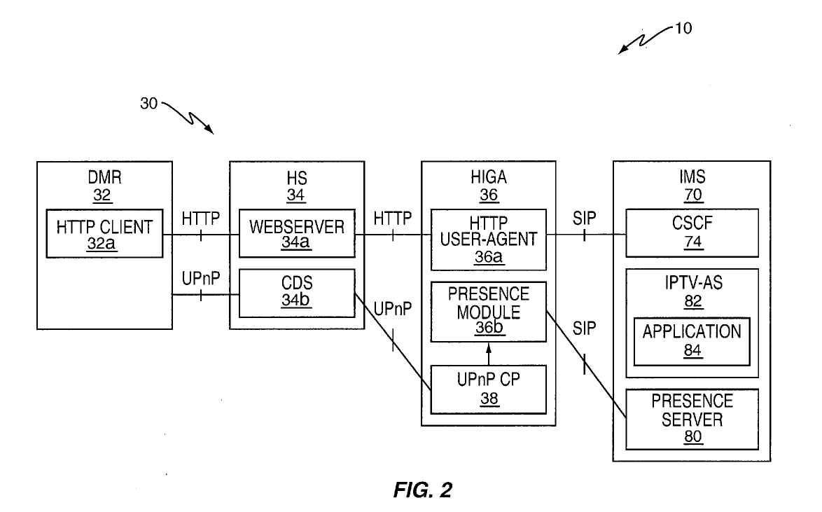

FIG. 2 illustrates some of the components of system 10 in more detail, and some suitable protocols that may be used to facilitate intercommunication according to one embodiment of the present invention. For illustrative purposes only, FIG. 2 is discussed in the context of the home theater system 30. However, those skilled in the art should appreciate that the following discussion can apply to any of the systems 30, 40, 50, and 60, of any of group member.

As seen in FIG. 2, TV 32 includes or is associated with a Hypertext Transfer Protocol (HTTP) client 32a. The HTTP client 32a may, for example, be located in a set-top box or in the TV 32 itself. HS 34 includes a web server application 34a and a Content Directory Service (CDS) 34b. The CDS 34b was standardized by the UPnP™ Forum in the “ContentDirectory:1 Service Template Version 1.01” dated Jun. 25, 2002, which is expressly incorporated herein by reference in its entirety. HIGA 36 includes or is associated with an HTTP user-agent 36a, a presence module 36b, and a Control Point (CP) 38. These entities utilize HTTP for signaling and Universal Plug-n-Play (UPnP) to communicate content. Each of these protocols are well-understood in the art, and thus, are not described in detail here.

HTTP client 32a communicates signaling information with a webserver 34a on HS 34 using the well-known HTTP protocol. The signaling messages may be requests for a desired media file stored on HS 34, or for an EPG from CDS 34b. The CDS 34b is periodically updated from the IPTV-AS 82, and contains a listing of the audio and/or video files available locally from HS 34, and/or from one or more of the other group members' systems 40, 50, 60.

Webserver 34a, in turn, communicates the signaling messages to/from an HTTP user agent 36a on HIGA 36. The HTTP user agent 36a translates the HTTP signaling messages into Session Initiation Protocol (SIP) messages for delivery to the IMS 70. The HTTP user agent 36a also translates SIP signaling messages received from the IMS 70 into HTTP signaling messages for delivery to HS 34. The CDS 34b communicates media content with the CP 38 using the UPnP protocol.

The HIGA 36 also includes a presence module 36b that communicates the presence status of the group member to the PS 80. The group member's presence status may change, for example, whenever the group member powers-on one or more components of system 30, or adds a media file to, or deletes a media file from, HS 34.

In one embodiment, for example, the CDS 34b automatically generates and transmits a signal to the CP 38 upon power up, or when the group member adds/deletes a media file. The signal may comprise information that details the available media files on HS 34. The information may, for example, specify a title of the media file, the type of content it contains (e.g., audio, video), and a URL or URI address that specifies where on the HS 34 the file is located. Upon receipt, the CP 38 notifies the presence module 36b. These notifications may include the information received from the CDS 34b. The presence module 36b then generates a SIP UPDATE message to include the information, and transmits the SIP UPDATE message to PS 80.

The IPTV-AS 82 is registered with PS 80 as a “watcher” to the group member. A watcher is a device or software program that registers with the PS 80 to receive presence updates of one or more devices as they occur. Thus, whenever the presence of one of the group members changes, the IPTV-AS 82 is appraised of the change in a presence update message. Typically, presence update messages describe the activity status of a user, such as “IDLE,” or “BUSY,” or “ON-LINE.” In the context of the present invention, however, the update messages may also include the listing of media files and their locations stored on HS 34. Upon receiving the presence update messages, application module 84 uses the information to generate or modify the group EPG. Once generated, the application module 84 distributes the generated group EPG to each group member. The group members can then display the group EPG and select a desired file from the EPG to render on their respective DMRS, such as TV 32.

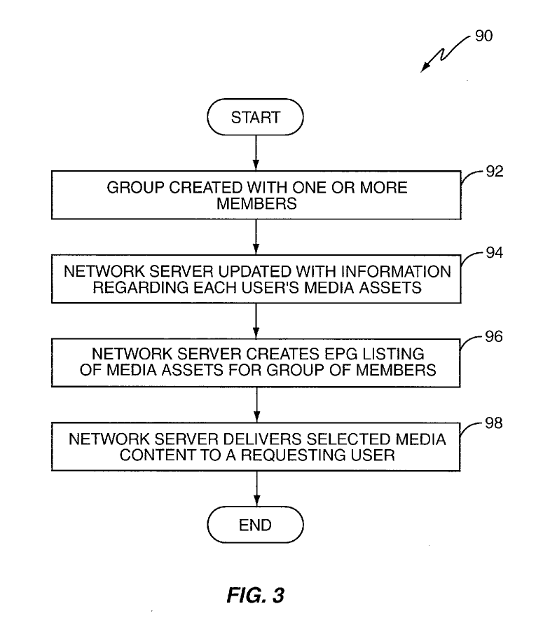

FIG. 3 is a flow diagram illustrating an exemplary method 90 for generating and distributing a group EPG based on the presence status of the group members. Using standard procedures and functions, a group is created, and its members register with the IMS 70 (box 92). The group members also set up and use their IPTV subscriptions. Next, the group members update their presence status with the PS 80 (box 94). With that change or update, information regarding each group member's media files is sent to the IPTV-AS 82 as previously described. The IPTV-AS 82 uses the information it receives to create the group EPG and distribute the EPG to the group members (box 96). Finally, the group member selects a desired media file from the distributed group EPG, which is delivered to the requesting group member via the IMS 70 as previously described for rendering (box 98). Thus, with the present invention, the group member can access a media file, even though the requested file may be physically located on a remotely located system, such as a home server in another group member's system.

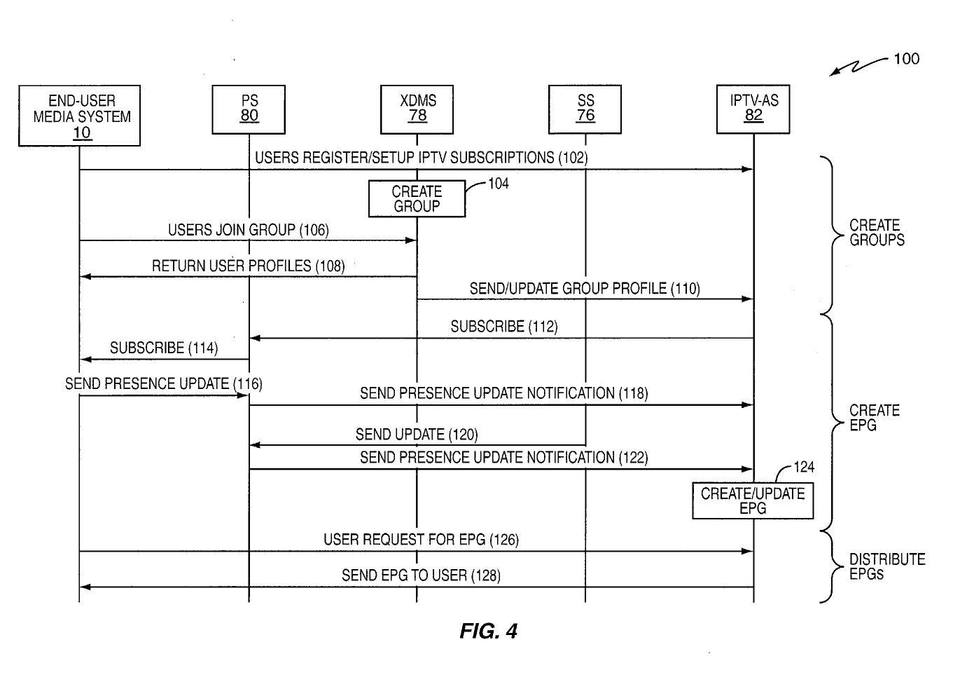

FIG. 4 is a call flow diagram 100 illustrating an exemplary method for creating group EPGs based on group membership and presence in the context of an IMS network. It is assumed that the individual users have registered in the IMS 70 and have set up their respective IPTV subscriptions with the IPTV-AS 82 (line 102). Further, it is assumed that the XDMS 78 has created an affinity group (box 104) and that the users have joined the affinity group (line 106). The procedures used to register the users, set-up their IPTV subscriptions, and create/update the affinity group are standard and well-known in the art. Therefore, these procedures are not detailed here.

After the users have joined the group, the XDMS 78 updates the system 30, 40, 50, 60 of each group member with a user profile (line 108). For home systems 30, 40, 50, the XMDS 78 may send an update message to the respective HIGAs 36, 46, 56 for storage in local memory. For mobile-based system 60, the XMDS 78 may send the user profile to device 62 for storage in local memory.

The XMDS 78 may also send a group profile to the IPTV-AS 82 (line 110). The group profile may contain information about the members of the group, such as their preferences and device capabilities. For example, some devices, such as wireless communication device 62 may be able to render audio, but not video, to a user. The IPTV-AS 82 can use this information to determine whether a specified type of file can be sent to such a device. Alternatively, the IPTV-AS 82 may use this information to exclude certain media files from an EPG intended for group members having devices not able to render them. Because the profile sent to the IPTV-AS 82 is a group profile, there is no need to send the individual user profiles to the IPTV-AS 82 for storage.

Once the group is created and its members registered, the IPTV-AS 82 can subscribe to receive presence updated from each of the group members, which may be sent when the group members update their shared media files. In the exemplary embodiment, the IPTV-AS 82 sends a SIP SUBSCRIBE message to the PS 80 for each group member (line 112). This registers the IPTV-AS 82 as a “watcher” for each group member, and thus, allows the IPTV-AS 82 to be kept informed of each group member's presence status. The PS 80 may send a SIP SUBSCRIBE message to each group member as is known in the art (line 114). As described in more detail later, the end-user systems 20 send presence update messages, such as SIP NOTIFY messages, to the PS 80 (line 116). These messages may be sent to the PS 80 when the users first join the affinity group, or whenever existing group members add or delete media files from their home systems. As previously described, the presence update messages include the presence status of the group members, as well as the information related to the media files stored at their respective systems 30, 40, 50, 60. Upon receipt, the PS 80 sends a presence update message to the IPTV-AS 82 (line 118).

It should be noted here that the devices for some systems, such as communication device 62 of system 60, may not be capable of storing a large number of media files. As such, at least some media files associated with the user of device 62 may be stored on SS 76. In these cases, the SS 76 may update the PS 80 with information about these media files (line 120) when the user joins the group or changes his media files. The PS 80 would then provide the IPTV-AS 82 with the presence update message as previously described (line 122). Once the IPTV-AS 82 receives the presence updates, the IPTV-AS 82 collates the received information with any information content that may already be stored for the other group members to generate the group EPG (box 124).

Once the IPTV-AS 82 generates the EPG, the IPTV-AS 82 can distribute the EPG to the members of the group. In this embodiment, the IPTV-AS 82 may receive requests from the group members for the EPG (line 126). The IPTV-AS 82 then distributes the group EPG to each group member that requests the EPG (line 128). The requests may be, for example, explicit requests generated by the group member. Alternatively, the requests for the EPG may be automatically generated and sent without the user's knowledge. Such implicit requests may occur, for example, whenever a group member powers-up an end-user system that has been configured by the user to perform this function. Alternatively, a given end-user system may request the EPG periodically, or it may automatically be updated whenever the status of another group member changes. In any case, the end-user system may receive all or a portion of the EPG. In some embodiments, the EPG can be pushed to the group members each time the EPG is updated.

A group member may then use the group EPG to access a desired media file associated with another member of the group. Particularly, the group member displays the group EPG, and selects a desired media file from the EPG. By way of example, the group member may select a video stored on the HS of another geographically distanced group member system. Responsive to the selection, the HIGA establishes a media session with the HS using known methods. The selected video file is then retrieved from its location on the HS and streamed to the group member that requested the media file.

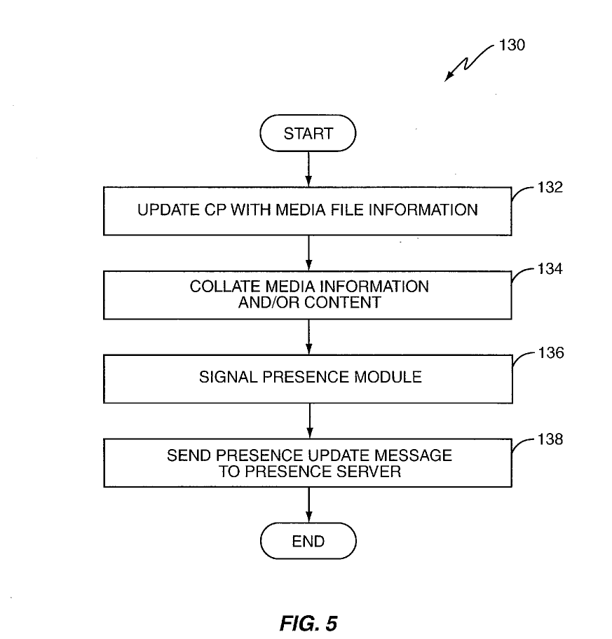

FIG. 5 illustrates an exemplary method 130 of generating and sending presence updates to the PS 80 from the end-user system 20. As previously stated, the media files associated with each group member are typically stored in the group member's HS. The end-user systems 20 would be responsible for providing a listing of their shared files when the user joins the group, or when the user changes the media files.

By way of example only, the media files of the group member associated with system 30 could be stored on HS 34. The CDS 34b includes a directory listing of those media files. Because the UPnP protocol is used in this embodiment, the CDS 34b automatically updates the CP 38 in the HIGA 36 with information related to the media files on HS 34 (box 132). The information may include the titles of one or more media files that the group member will share with the other group members, and a location of those media files such as a URL, for example, that defines where a media file is located on HS 34. In some embodiments, the information may include a copy of the media file content.

The CP 38 then collates the information and/or content (box 134) and signals the presence module 36b (box 136). Responsive to the signal, the presence module 36b generates the presence update message to include the media information, and sends the presence update to the PS 80 (box 138). The PS 80 then forwards the presence update and the information to the IPTV-AS 82 as previously described.

Generating the group EPG may increase the processing load of the IPTV-AS 82. Therefore, the IPTV-AS 82 need not generate the group EPG. In some embodiments, a separate network server connected to the IPTV-AS 82 performs this function. For example, the IPTV-AS 82 could communicate the presence updates to a separate EPG server for EPG generation. Once complete, the EPG server would communicate the updated EPG to the IPTV-AS 82 for dissemination to the end-user systems 20. Offloading the EPG generation functions to a separate server would allow the IPTV-AS 82 to perform its other conventional functions and minimize any delays that the extra processing might incur.

Distributing the group EPG to the group members' respective systems 30, 40, 50, 60 may be performed using any method known in the art. By way of example, the IPTV-AS 82 may push the group EPG to each group member using SIP or HTTP. Alternatively, the IPTV-AS 82 may send a SIP message to each system 30, 40, 50, 60 to notify each system that an updated group EPG is available. Responsive to this trigger, the HIGAs, for example, could request and receive the updated group EPG using one or more messages formatted according to a protocol such as SIP, HTTP, SMS, or the like.

Each of the group members can determine when and how they receive the group EPG based on their presence. For example, a group member's presence may be updated whenever the member watches TV. In such cases, the IPTV-AS 82 may not send updated EPGs to that group member while that group member is watching TV. Additionally, the EPGs can indicate to the other members that the group member is watching TV, and in some embodiments, which TV program the group member is watching.

Further, where media files are shared between group members, the group membership is used as the authorization. Thus, the HIGA, for example, can access the group membership list responsive to receiving a request for a particular file. If the requesting party is a member of the group, that user is authenticated and authorized to receive the requested file. Otherwise, that user request is denied. This negates the need for a system to individually query a requesting user for authentication.

Additional security is also possible, however. For example, one embodiment requires that each group have one or more uniquely assigned broadcast channels. Information regarding these assignments may be transmitted to the group members as part of the group EPG. Thereafter, any request for a media file that is received over one of the identified broadcast channels is considered authenticated.

In other embodiments, the distributed EPG may carry signed URLs associated with the media files. Whenever a user requests a media file, the HIGA sends the signed URL to establish the media channel. Because the URL is signed, the HIGA/HS retrieving the media file can authenticate the user. Other methods, such as the use of individual or group-level passwords, are also suitable.

The present invention also facilitates digital rights management and billing functions. For example, charging group members for the media files may be applied at a group level or to individual group members using the profiles stored at the XDMS 78. Charges may be based on a URL associated with a selected file and billed in any manner known in the art.

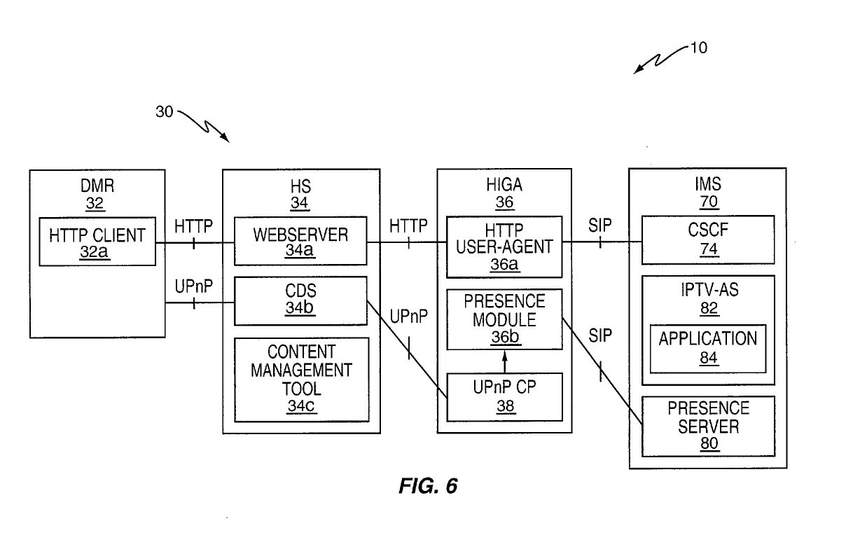

FIG. 6 illustrates another embodiment in which HS 34 includes a content management tool 34c. With this software module, the group member associated with system 30 can control access to media files stored on HS 34 by specifying which of the other group members can or cannot access a given media file. Additionally, the group member could use the content management tool 34c to specify whether a given media file should be marked for home-use only, and thus, not published to the other group members. Such control may be provisioned when the group member adds the media file to the home server, for example, or when the group member desires to alter the access rights to one or more media files.

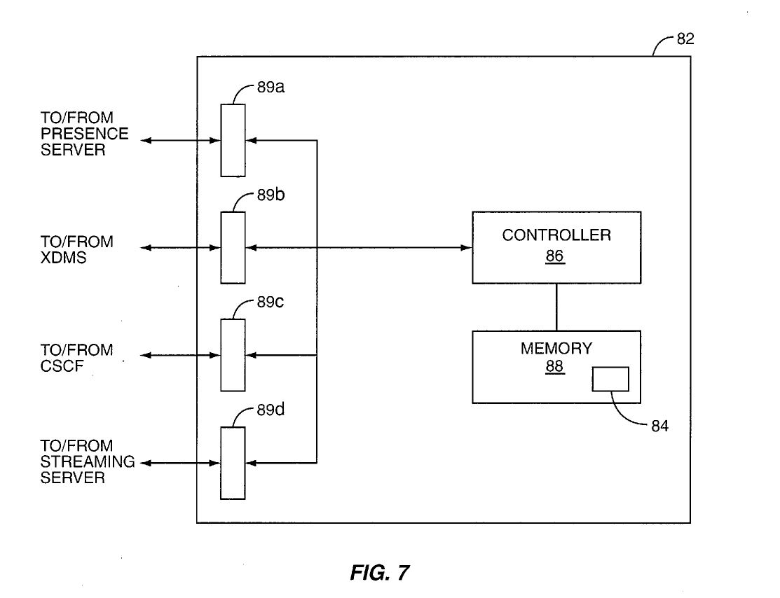

FIG. 7 is a block diagram illustrating some of the component parts of the IPTV-AS 82. As seen in FIG. 7, the IPTV-AS 82 comprises a controller 86, a memory 88, and a communication interface 89. The controller may, for example, be any of a variety of programmable microprocessors that control the operation of IPTV-AS 82 according to instructions and data stored in memory 88. Such program instructions include, for example, the application module 84 that generates and distributes the group EPG from the received presence updates. The communication interface 89 includes interfaces that permit the IPTV-AS 82 to communicate with one or more network entities using an appropriate protocol. Interface 89a, for example, communicatively connects the IPTV-AS 82 to the PS 80. Presence notifications are sent and received over this interface. Interface 89b allows the communication of user and group profiles with the XDMS 78. Interface 89c, which may comprise an IP. multimedia service control (ISC) interface, facilitates communications with the CSCF 84, and interface 89d permits communications with SS 76.

As previously stated, the IPTV-AS 82 receives presence updates and composes a group-specific EPG based on those presence updates. These functions may occur periodically at predetermined time intervals, whenever the presence of one or more group members changes, whenever a group member requests the group EPG, or responsive to some combination thereof.

Further, generating the EPG may be based on information included in some or all of the individual group member profiles, or in the conglomerate group member profile. The IPTV-AS 82, for example, may process this information to determine user preferences and capabilities, and to determine the content of the group EPGs or individual EPGs distributed to the group members.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of creating an electronic guide for a group, the method comprising:
receiving presence updates from one or more group members, the presence updates including information about media content shared by the group members; and
generating an electronic guide for the group members, the electronic guide including the information about the shared media content.

2. The method of claim 1 further comprising distributing the electronic guide to the group members.

3. The method of claim 2 wherein distributing the electronic guide to the group members comprises sending the electronic guide to one or more of the group members responsive to receiving a request for the electronic guide.

4. The method of claim 1 wherein generating an electronic guide for the group members comprises compiling the information about the shared media content received from the group members responsive to receiving the presence update.

5. The method of claim 4 wherein the information about the shared media content comprises a title of a shared media file stored at a home system of a group member.

6. The method of claim 5 wherein the information about the shared media content further comprises a location in the home system where the shared media content is stored.

7. The method of claim 4 wherein the information about the shared media content comprises a media type for the shared media content.

8. The method of claim 1 wherein the electronic guide further includes authentication information that the group members use to authenticate requests for shared media content from the other group members.

9. The method of claim 8 wherein the authentication information identifies one or more broadcast channels assigned to the group.

10. The method of claim 1 further comprising receiving profile information about the group members from a network server, and generating the electronic guide for the group members based at least in part on the received profile information.

11. A server in a communication network, the server comprising:
a communication interface; and
a controller configured to:
receive presence updates associated with a member of an affinity group via the communication interface, the presence updates including information about media content shared with the other members of the group; and
generate an electronic guide that includes the information about the shared media content for the group members.

12. The server of claim 11 wherein the controller is further configured to compile the information about the shared media content responsive to receiving the presence updates.

13. The server of claim 12 wherein the information about the shared media content identifies a media file stored at a home system associated with the group member.

14. The server of claim 11 wherein the controller is further configured to send the electronic guide to a user if the user is a member of the group.

15. The server of claim 11 wherein the controller is further configured to subscribe to receive presence updates associated with one or more of the group members.

16. The server of claim 11 wherein the electronic guide comprises at least one of an electronic program guide (EPG) and an electronic service guide (ESG).

17. The server of claim 11 wherein the controller is further configured to receive profile information about the group members from a network server and to generate the electronic guide based on the received profile information.

18. A method of creating an electronic guide for the members of a group, the method comprising:
identifying media content shared with members of an affinity group over a communication network; and
sending presence update messages that include information about the shared media content to a subscriber.

19. The method of claim 18 wherein sending presence updates to a subscriber comprises compiling the information about the shared media content and including the information in the presence updates.

20. The method of claim 19 wherein the information about the shared media content comprises a title of a media file shared with the members of the affinity group.

21. The method of claim 20 wherein the information further comprises a location of the shared media file stored on a device at a home system associated with a group member.

22. The method of claim 18 further comprising receiving an electronic guide from a server in the communication network, the electronic guide including information about media content being shared by the other members of the affinity group.

23. The method of claim 22 wherein the electronic guide includes authentication information, and further comprising authenticating a group member requesting media content based on the authentication information.

24. The method of claim 23 wherein the authentication information identifies one or more broadcast channels assigned to the affinity group, and wherein the group member is authenticated if a request for the media content is received from the group member over one of the identified broadcast channels.

25. The method of claim 24 wherein the authentication information comprises a signed Uniform Resource Identifier (URI) associated with the requested media content.

26. The method of claim 18 further comprising generating a request for shared media content from a group member, wherein the request includes a signed URI associated with the requested media content.

27. A communication device comprising:
an interface configured to communicate data with a subscriber;
a presence module configured to send presence update messages to the subscriber, the presence update messages including information about media content shared with members of an affinity group.

28. The device of claim 27 wherein the information about the shared media content comprises a title of a shared media file stored by a group member.

29. The device of claim 27 wherein the information about the shared media content comprises a location of the shared media file at a home system associated with a group member.

30. The device of claim 27 wherein the presence module is further configured to receive updates about the shared media content from a media system associated with a group member.

31. The device of claim 27 wherein the device comprises a wireless communication device associated with a group member.

32. The device of claim 27 wherein the device comprises a server at a home media system of a group member.

33. The device of claim 27 wherein the device comprises a digital media rendering device at a home media system of a group member.

34. The device of claim 27 wherein the interface is further configured to receive an electronic guide identifying the shared media content of the members of the affinity group, and authentication information used by the device to authenticate a group member that requests the shared media content.
